(19) United States
(12) Patent Application Publication
(10) Pub. No.: US 2010/0186180 A1
(43) Pub. Date: Jul. 29, 2010

(54) SUPPORT STRUCTURE FOR MULTIPLE WORKPIECE SUPPORT ROLLERS

(75) Inventor: Kenneth C. Miller, Aptos, CA (US)

Correspondence Address: MARTINE PENILLA & GENCARELLA, LLP, 710 LAKEWAY DRIVE, SUITE 200, SUNNYVALE, CA, 94085, US

(73) Assignee: Xyratex Corporation

(21) Appl. No.: 12/359,173

(22) Filed: Jan. 23, 2009

(51) Int. Cl. A47L 15/39; B23Q 1/64

(52) U.S. Cl. 15/77; 269/57

(57) ABSTRACT

Apparatuses for supporting a workpiece are disclosed. In one example, the apparatus includes a plurality of shaft supports. The apparatus further includes a shaft defined between the shaft supports, the shaft extending through an aperture defined in each of the plurality of shaft supports. Further included in the apparatus is a plurality of rollers defined to rotate about the shaft, the rollers defined between the plurality of shaft supports.

### BACKGROUND

Many processes for semiconductor and disk manufacturing require extremely clean workpieces before the processes may start. For example, particulates or contaminates that attach to or form on the workpiece before processing may eventually cause defects in the workpiece. When the workpieces are disks to be processed, such particulates or contaminates may be hydrophobic or hydrophyllic, and may include layers: e.g., thin oxide surface layers; surface asperities such as scratches, nodules, and ridges that may be induced by a prior polishing operation; materials adhered to the workpiece due to the polishing operation; and loosely adhered particles from the environment in which the workpiece has been stored. These particulates or contaminates may also be aged, and thus be more stable and more difficult to remove before the processing. Cleaning, then, is a process intended to remove substantially all of such particulates or contaminates from workpieces before processing, such as processing of magnetic media or semiconductor workpieces. A clean workpiece is thus a workpiece from which substantially all of such particulates or contaminates have been removed before processing.

Therefore, there is a need for improving techniques for cleaning workpieces, such as those workpieces that present problems and require removal of substantially all of such particulates or contaminates from the workpieces before processing. Moreover, these improved techniques must allow cleaning of a workpiece to be done quickly so as to reduce the cost of capital equipment for the cleaning.

What is needed then, is apparatus configured to clean workpieces quickly, yet during the cleaning operation of one workpiece, to increase the time provided for contact at the brush-workpiece interface according to characteristics of the workpiece. What is also needed is apparatus configured to clean a group of workpieces, wherein all workpieces of the group are cleaned by the same apparatus,. It is within this context that embodiments of the invention arise.

### SUMMARY OF THE INVENTION

Broadly speaking, embodiments of the present invention fill these needs by providing methods of and apparatus configured to support the efficient cleaning of the workpieces. In one embodiment, an apparatus for supporting a workpiece is provided. The apparatus includes a plurality of shaft supports and a shaft defined between the shaft supports. The shaft extends through an aperture defined in each of the plurality of shaft supports. Additionally, there are a plurality of rollers defined to rotate about the shaft where the rollers are defined between the plurality of shaft supports.

In another embodiment, an apparatus for supporting a semi-conductor substrate is disclosed. The apparatus includes a first carrier that has a plurality of support slots formed on an interior face. The apparatus also includes a second carrier that opposes the first carrier, the second carrier having a plurality of support slots on an interior face. Also included in the apparatus is a plurality of shaft supports that are positioned within the support slots. Each of the shaft supports has an aperture that extends from respective carriers. The apparatus further includes a shaft that is defined through the apertures along a length of the respective carriers. Additionally, the apparatus includes a plurality of rollers defined to rotate about the shaft where the rollers are defined between the plurality of shaft supports.

In still another embodiment, a substrate cleaning apparatus is disclosed. The apparatus includes a brush member that has an axis of rotation and further has scrubbing material to clean a substrate. The apparatus also includes a support member that supports a substrate in contact with the brush. The support member includes a shaft that is defined through apertures on a plurality of shaft supports. The shaft configured to extend through an aperture defined in each of the plurality of shaft supports. Additionally, the shaft has a plurality of rollers defined between the plurality of shaft supports where the plurality of rollers are further defined to rotate about the shaft.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1A is an exemplary illustration of a support structure in accordance with one embodiment of the present invention.

FIG. 1B is a simplified schematic diagram illustrating a cleaning apparatus that the support structure may be integrated with, in accordance with one embodiment of the invention.

FIG. 2 is a schematic illustrating roller assemblies along with the disc in accordance with one embodiment of the present invention.

FIG. 3 is an exemplary illustration of the roller assembly where one of the carriers has been made semi-transparent in order to show carrier features, in accordance with one embodiment of the present invention.

FIGS. 4A through 4D are an exemplary rendering of the carrier with various numbers of supports and rollers to show various aspects of the interaction between parts, in accordance with one embodiment of the present invention.

FIG. 5 includes an exploded view of the roller assembly in accordance with one embodiment of the present invention.

FIG. 6 is schematic illustrating various views of the carrier in accordance with one embodiment of the present invention

FIG. 7 includes exemplary views of a roller, in accordance with one embodiment of the present invention.

FIG. 8 is a schematic of an exemplary shaft support, in accordance with one embodiment of the present invention.

FIGS. 9A-9F illustrate alternate rollers that incorporate a spring in accordance with one embodiment of the present invention.

### DETAILED DESCRIPTION

The embodiments described below relate to apparatus for supporting a workpiece during cleaning. In one embodiment, the apparatus may be used to support magnetic disks that store data. It should be appreciated that the embodiments are not limited to supporting magnetic disks, in that any semiconductor circuit device, flat panel display, or other substrate may be supported for cleaning by the embodiments described herein. The term workpiece as used herein may refer to any substrate being processed. In addition, the terms disk and disc are used interchangeably, and may also reference any such substrate or workpiece. In one embodiment, the support may be used to convey the work pieces during a scrubbing operation. For example, the support can be utilized for a cleaning operation with a spiral scrubbing operation and apparatus as described in U.S. patent application Ser. No. 11/862,170. The support acts as a carriage that allows the discs or workpieces to rotate about an axis with some compliancy and contemporaneously accommodates the linear movement of the workpieces.

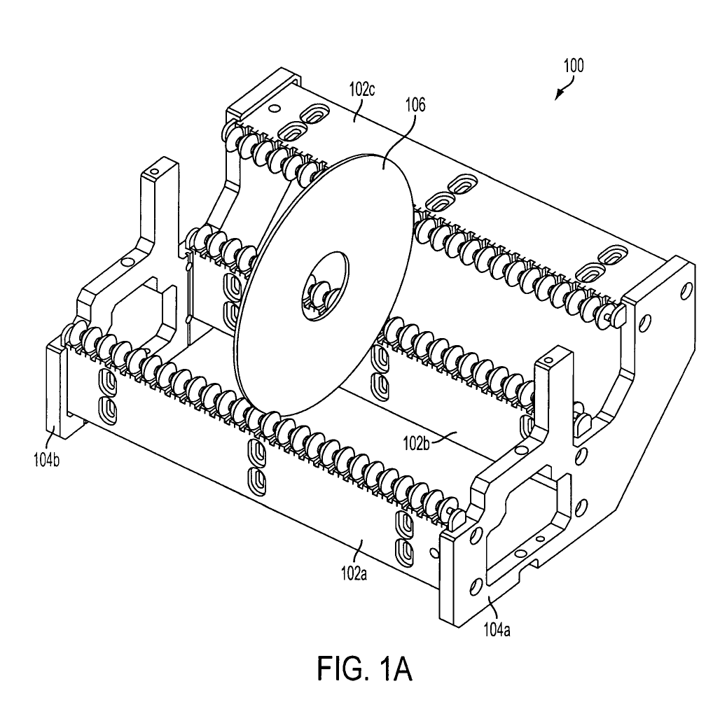

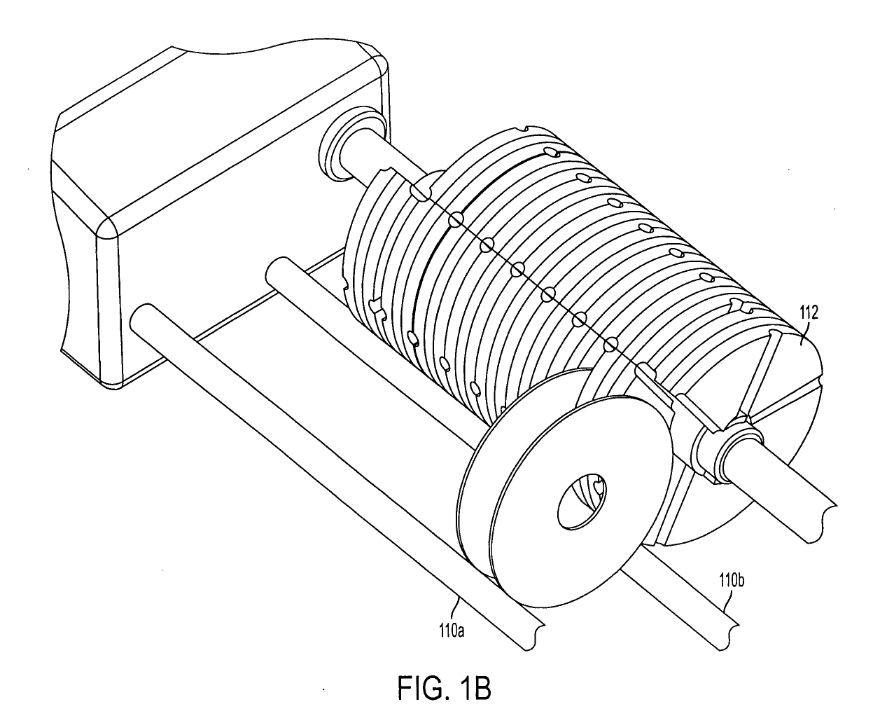

FIG. 1A is an exemplary illustration of a support structure 100 in accordance with one embodiment of the present invention. The support structure 100 includes frame 104a and frame 104b along with roller assemblies 102a, 102b, and 102c disposed between opposing surfaces of frames 104a and 104b. Removable fasteners can be used to secure the roller assemblies 102a, 102b and 103c between the opposing surfaces of frame 104a and 104b. In one embodiment, the removable fasteners are machine screws while other embodiments employ other known types of fasteners. Roller assemblies 102a and 102b support a disc 106 vertically while roller assembly 102c supports the disk 106 horizontally. In some embodiments, a moveable fourth roller assembly (not shown) is used to hold the disc 102 in place during cleaning operations. The moveable fourth roller assembly can be secured to the frames 104a and 104b or be part of a separate assembly.

While illustrated with a disc 106, the roller assemblies are configured to accommodate multiple discs that are placed into the support structure 100 by an automated carrier moving between roller assembly 102a and roller assembly 102b. The distance between roller assembly 102a and roller assembly 102b defines the width of a support nest (not shown). Features of the roller assembly 102a and 102b enable support nests that can accommodate large diameter discs while in other configurations enabling accommodation of smaller diameter discs. Note that the relative size of the support structure 100 shown in FIG. 1 is not intended to be limiting. The support structure 100 can be modified in order to accommodate more or fewer discs.

FIG. 1B is a simplified schematic diagram illustrating a cleaning apparatus that the support structure 100 may be integrated with, in accordance with one embodiment of the invention. The support structure 100 is configured to replace supports 110a and 110b in order to expose discs within the support structure 100 to be processed with brush apparatus 112. In one embodiment, the apparatus 112 is a spiral scrubber that conditions the surface of the discs by removing residual particular matter. For additional information regarding the spiral scrubber, see U.S. patent application Ser. No. 11/862,170, the contents of which are incorporated herein by reference.

As the roller assembly 102 of the support structure 100 allows the discs to rotate, the entire surface of the discs can be exposed to the apparatus 112. Additionally, the v-shape groove of the individual rollers encourages even spacing of the discs and minimizes contact with the disc. In other embodiments, the apparatus 112 is a cleaning apparatus with evenly spaced cleaning surfaces that are not in a spiral configuration. In one embodiment the cleaning apparatus is a brush with slits that enable the brush to scrub opposing surfaces of a disc or substrate. The rotation of apparatus 112 imparts linear forces so that the carriage or support structure translates along a length of the brush of the scrubbing apparatus. It should be noted, that the support structure can be moved into position onto a processing tool via a robot in order to minimize human contact and possible contamination points.

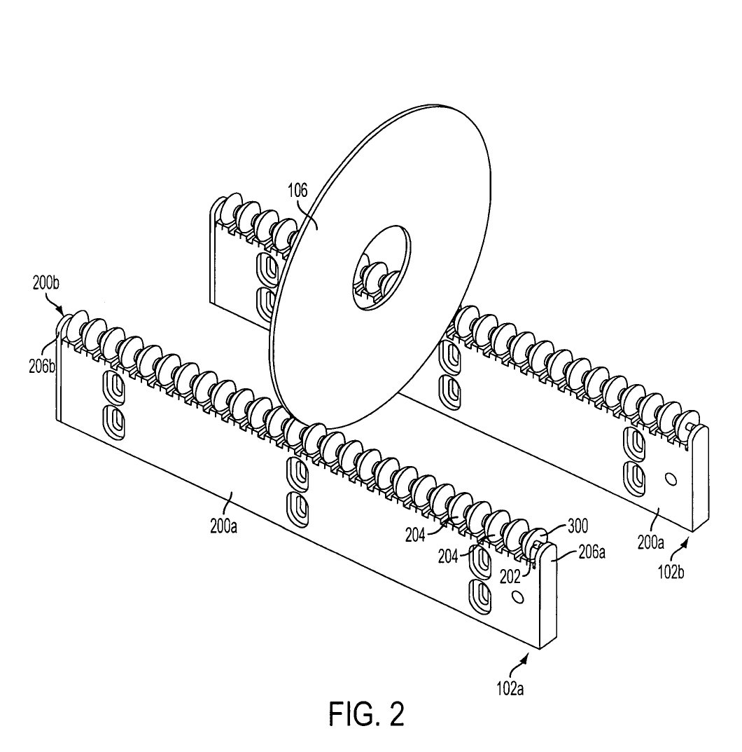

FIG. 2 is a schematic diagram illustrating roller assemblies 102a and 102b along with disc 106 in accordance with one embodiment of the present invention. The roller assembly 102a includes a carrier 200a, a carrier 200b, a shaft 202 and multiple rollers 204. The carriers 200a and 200b include a shaft stop 206a and 206b. The shaft stops 206a and 206b are located on the end of the respective carriers 200a and 200b and keep the shaft 202 from sliding out of the roller assembly 102. In one embodiment the carriers 200a and 200b are formed based on a common design and mated together so the shaft stops 206a and 206b are on opposing ends of the roller assembly 102a.

In FIG. 2, a single support 300 is visible. However, multiple supports 300 are located between the carriers 200a and 200b in order to support the shaft 202 between the rollers 204. An aperture of the support 300 is shown protruding from the carriers 200a and 200b. Location of the support 300 within the carriers 200a and 200b defines the location of the aperture. In the embodiment illustrated, the aperture is a hole within the support 300 and the shaft 202 is threaded through the aperture. In other embodiments, the aperture can be a portion of a cutout such as a semi-circle so the shaft 202 rests on the support 300. As will be discussed below, features formed on interior faces of the carriers 200a and 200b and features of the support 300 promote accurate placement of the supports 300 to minimize deflection of the shaft 202.

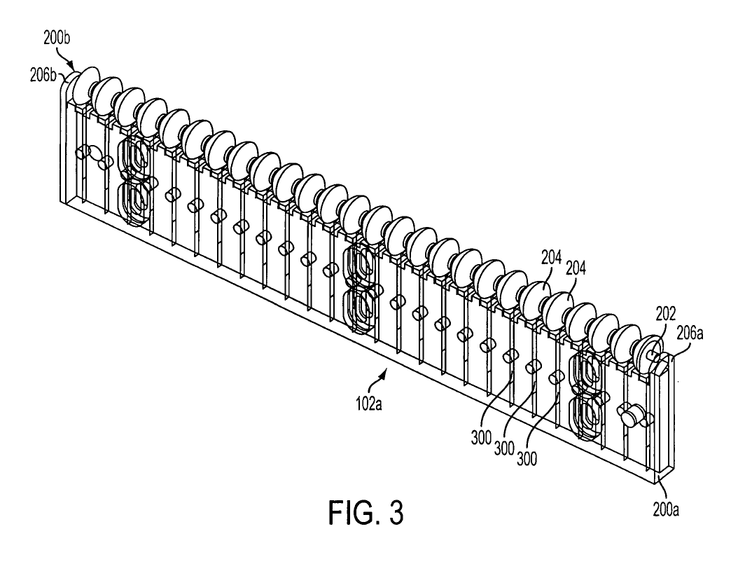

FIG. 3 is an exemplary illustration of the roller assembly 102a where carrier 200a has been made semi-transparent in order to show features within carriers 200a and 200b, in accordance with one embodiment of the present invention. The carriers 200a and 200b include features on an inside face that accommodate multiple shaft supports 300. Individual rollers 204 are supported and located on the shaft 202 between the shaft supports 300. In one embodiment, the v-shape of the individual rollers 204 assists in maintaining the discs evenly spaced. Similarly, the v-shape of the individual rollers 204 prevents excessive lateral movement of the discs that can damage the surface of the discs. The shaft supports 300 constrain the movement of the rollers 204 and provide support for the shaft 202. Shaft supports 300 prevent flexing of the shaft 202 and allow the diameter of the shaft 202 to be minimized. In one embodiment, the shaft material is a rigid material such as stainless steel. In other embodiments, alternate materials can be used such as titanium. The particular shaft materials examples provided are exemplary and should not be construed as limiting.

By minimizing the diameter of the shaft 202, rollers 204 can be of a smaller diameter. The user of smaller diameter rollers enables support nests that can accommodate smaller diameter discs while still allowing a cleaning apparatus, such as the spiral brush apparatus to access the surface of the discs. In one embodiment, rollers 204 are composed of a compliant material formed over a rigid sleeve that may slightly deform to conform to an edge of the discs. An exemplary material for the rollers is, but is not limited to urethane.

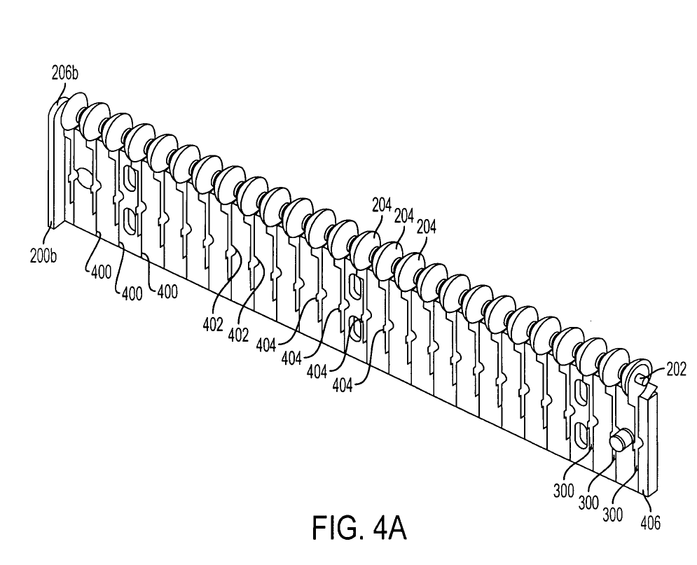

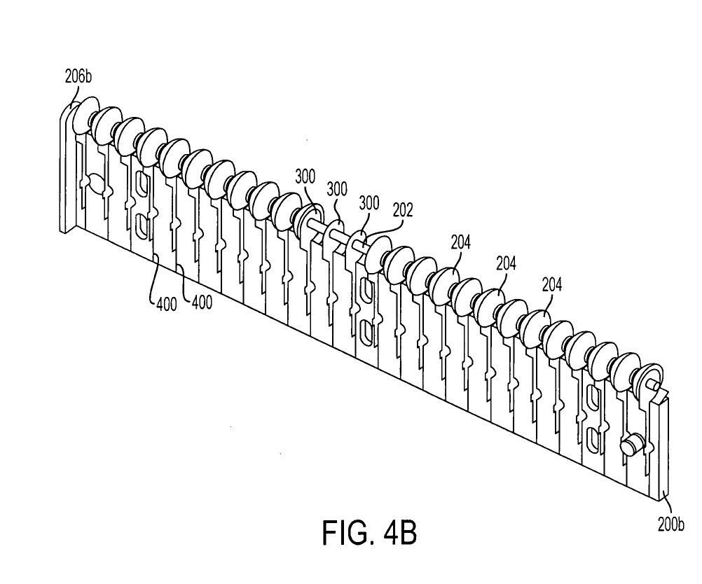

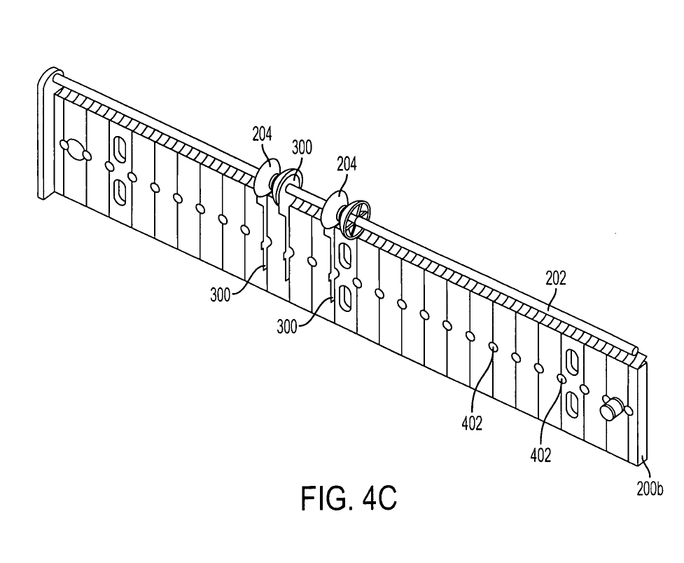

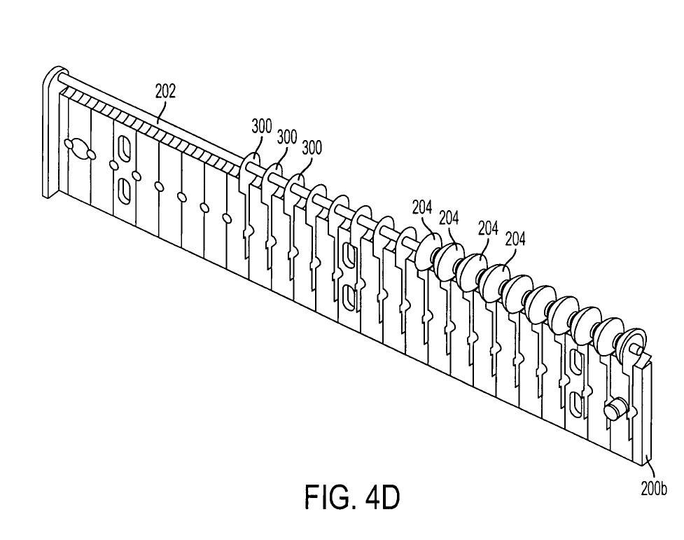

FIGS. 4A through 4D are an exemplary rendering of the carrier 200b with various numbers of shaft supports 300 and rollers 204 to illustrate various aspects of the interaction between parts, in accordance with one embodiment of the present invention. In FIG. 4A, the carrier 200a has been removed leaving only carrier 200b along with supports 300, rollers 204, and the shaft 202. Without carrier 200a and the associated shaft stop 206a, one end of the shaft 202 is clearly visible. Additionally, support slots 400 are visible within the inside face 406 of the carrier 200b. The support slots 400 accommodate the shaft supports 300 and can include a shaft support locator 402 or keying feature to accurately locate the shaft supports 300 within the support slot 400. Similarly, the shaft supports 300 have a locator 404 or key feature that is aligned with the shaft support locator 402. As the shaft 202 is supported by the shaft supports 300, accurate location of the supports can assist in preventing flexing or undulations within the shaft 202.

FIG. 4B is a representative illustration showing the removal of some rollers 204 in order to provide a view of the shaft supports 300 and the shaft 202 while installed in the carrier 200b, in accordance with one embodiment of the present invention. Removal of some of the rollers reveals that the shaft supports 300 are anchored within the carrier 200b and help prevent lateral movement of the rollers 204 along the length of the shaft 202. In one embodiment, the thickness of the supports 300 is minimized in order to maximize the width of the rollers. Maximizing the width of the rollers allows the discs to be spaced far enough apart so a process, such as scrubbing can be conducted on the surfaces of the discs. In various embodiments, the thickness of the supports 300 is within a range of about 0.005 to 0.02 inches. In one embodiment, the thickness of the supports 300 is 0.01 inches and the supports 300 are fabricated from stainless steel. The use of stainless steel for supports 300 should not be considered limiting as alternate materials for supports 300 can be used.

FIG. 4C is another representative illustration of the carrier 200b in accordance with one embodiment of the present invention. FIG. 4C illustrates the shaft 202 running through a roller 204 between two shaft supports 300 along with a roller 204 being supported by a single shaft support 300. In this embodiment, the rollers are able to spin on the shaft while lateral movement is restricted by the shaft supports 300. As will be discussed later, other embodiments of the rollers incorporate or include spring elements that enable the rollers 204 to center themselves between the shaft supports 300. FIG. 4C also provides a view of the shaft support locators 402 that accommodate the support locator.

FIG. 4D illustrates still another schematic of various components being installed in the carrier 200b, in accordance with an embodiment of the present invention. This illustration shows the shaft 202 along with a portion of the carrier 200b without shaft supports 300, a portion of the carrier 200b with shaft supports 300, and a portion of the carrier 200b with both shaft supports 300 and rollers 204. The rollers 204 are independently supported between the shaft supports 300 and can each rotate independently of another. Being able to rotate independently of the other allows the rollers 204 to accommodate variations of disc rotational speeds and movement within a set of multiple discs being processed. The use of individual rollers 204 also reduces potential damage to discs along with reducing roller wear and particle generation during an exemplary cleaning operation. Shaft supports 300 may be disposed between each roller 204 or periodically after some number of rollers.

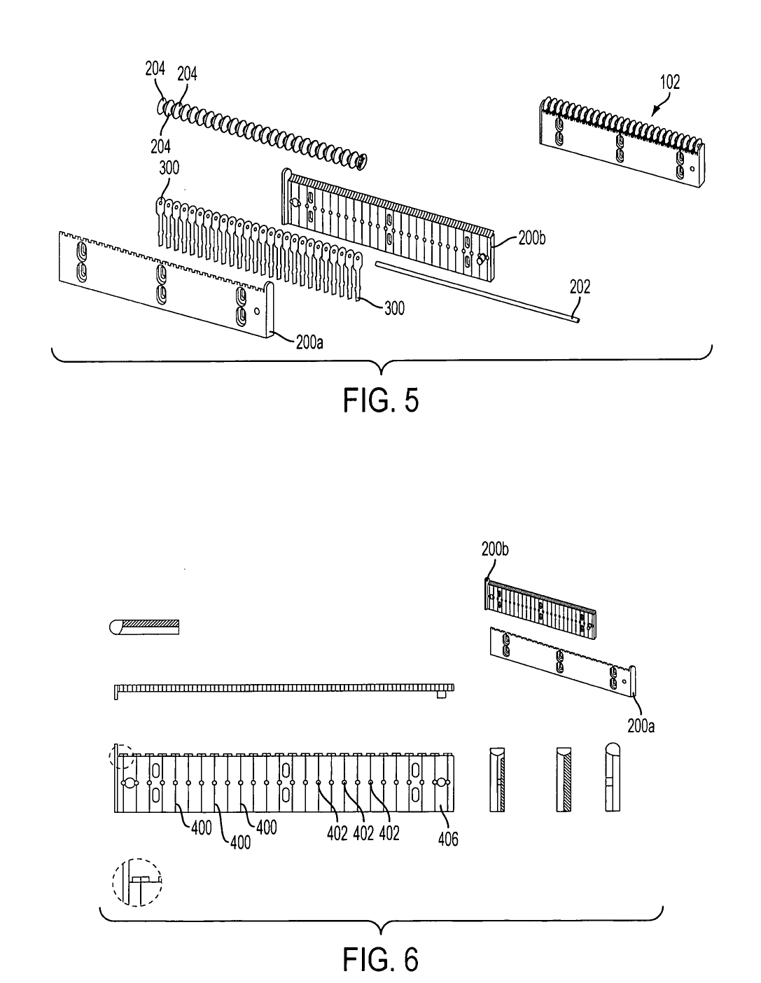

FIG. 5 is an exploded view of the roller assembly 102 in accordance with one embodiment of the present invention. This illustration provides a relative view of the carriers 200a and 200b, along with the shaft 202, rollers 204 and shaft supports 300. In various embodiment, shaft 202 is composed of stainless steel and has a diameter within a range of about 1 mm to about 3 mm. In one particular embodiment, the shaft 202 has a diameter of about 2 mm. Stainless steel has been listed as an exemplary material for the shaft 202 because the material minimizes the potential to generate contaminates. The use of stainless steel as the shaft 202 material should not be construed as limiting as other materials that minimize contaminate generation can also be used.

FIG. 6 is a schematic illustrating various views of the carriers 200a and 200b in accordance with one embodiment of the present invention. FIG. 6 illustrates that the carrier 200a and 200b are formed from a common design with carrier 200b being positioned to mirror carrier 200b. The support slots 400 along with the shaft support locators 402 can be seen formed on the inside face 406 of the carrier 200a and 200b.

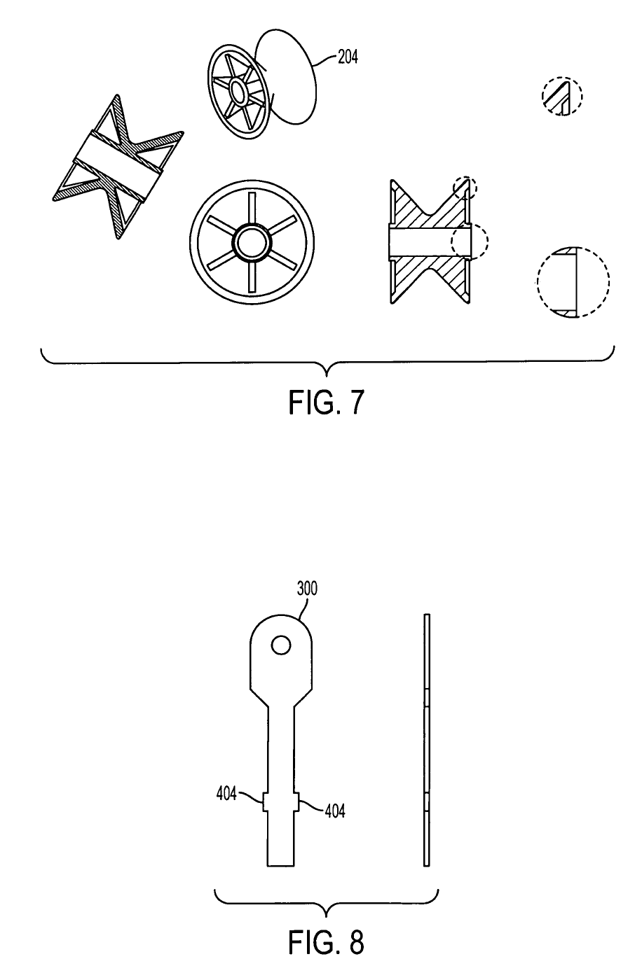

FIG. 7 includes exemplary views of a roller 204, in accordance with one embodiment of the present invention. The roller 204 is intended to be merely an example and should not be considered limiting. Other embodiments of rollers can include integrated ball bearings or replaceable bearings to reduce particle generation from friction between the roller and the shaft. Roller 204 is shaped as a v-shaped outer surface disposed around a slot accommodating the shaft. Triangular supports extend from a center region of the roller outward.

FIG. 8 is a schematic of an exemplary shaft support 300, in accordance with one embodiment of the present invention. In this figure, the support locator 404 is illustrated as having a lower extension member with a wider head disposed thereon. An aperture within the head portion is configured to receive a shaft therethrough. As previously discussed, the support locator 404 is matched with the carrier locator (not shown) in order to accurately locate the shaft support 300. With the shaft supports 300 being accurately located and supported, a shaft with a minimal diameter can be used because deflection of the shaft from the supports is minimized.

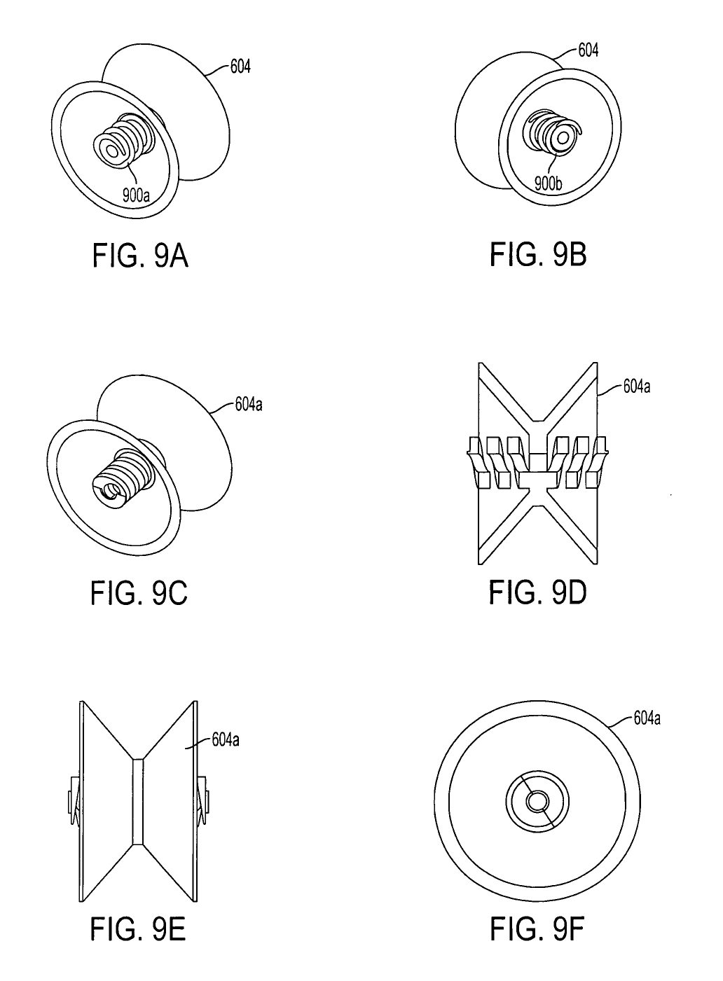

FIGS. 9A-9F illustrate alternate rollers 604 that incorporate a spring 900 in accordance with one embodiment of the present invention. In FIGS. 9A and 9B, the roller 604 accommodates a spring 900a while in FIGS. 9C-9F the roller 604a includes an integrated spring. In each embodiment, the spring centers the roller between supports (not shown). While both of the embodiments illustrated rely on coil springs, other embodiments can rely on different types of spring or even compliant materials such as, but not limited to compliant elastomerics. Additionally, movement of the disc can be accommodated by the springs so as to reduce uneven loading of the roller on the shaft. This can result in reduced particulate generation and reduced wear on the rollers. Furthermore, the potential for damaging the edges of discs can be reduced with the motion compliance afforded by the use of spring on the rollers.

Although the foregoing invention has been described in some detail for purposes of clarity of understanding, it will be apparent that certain changes and modifications may be practiced within the scope of the appended claims. For example, in an alternative embodiment, the supports are insert molded into a one-piece component that has a single shaft stop added after the installation of the rollers and the shaft.

Accordingly, the present embodiments are to be considered as illustrative and not restrictive, and the invention is not to be limited to the details given herein, but may be modified within the scope and equivalents of the appended claims.

What is claimed is:

1. An apparatus for supporting a workpiece, comprising:
a plurality of shaft supports;
a shaft defined between the shaft supports, the shaft extending through an aperture defined in each of the plurality of shaft supports; and
a plurality of rollers defined to rotate about the shaft, the rollers defined between the plurality of shaft supports.

2. An apparatus as defined in claim 1, further comprising:
a first carrier and a second carrier, each carrier having a plurality of matching support slots formed on an interior face of the first and second carriers.

3. An apparatus as defined in claim 2, wherein the shaft supports are positioned within the support slots defined on the interior face of the first and second carriers.

4. An apparatus as defined in claim 3, wherein the support slots include a keying feature to align the aperture of the shaft support.

5. An apparatus as defined in claim 2, wherein each carrier has a shaft stop, the shaft stop being configured to retain the shaft between the shaft stop of each carrier.

6. An apparatus as defined in claim 1, wherein compliant members are mounted along the shaft between each of the plurality of rollers and the respective shaft supports.

7. An apparatus for supporting a substrate, comprising:
a first carrier having a plurality of support slots formed on an interior face;
a second carrier opposing the first carrier, the second carrier having a plurality of support slots on an interior face;
a plurality of shaft supports being positioned within the support slots, each of the shaft supports having an aperture that extends from respective carriers;
a shaft being defined through the apertures along a length of the respective carriers; and
a plurality of rollers defined to rotate about the shaft, the rollers defined between the plurality of shaft supports.

8. An apparatus as defined in claim 7, wherein the support slots include a keying feature to align the aperture of the shaft support.

9. An apparatus as described in claim 8, wherein the shaft supports have a key feature that corresponds to the keying feature of the support slots.

10. An apparatus as described in claim 9, wherein the key feature is located on an opposite end of the aperture.

11. An apparatus as described in claim 7, wherein the plurality of rollers include an integrated compliant member.

12. An apparatus as described in claim 9, wherein the key feature extends past the interior face of the carrier.

13. An apparatus as described in claim 7, wherein the shaft has a diameter of about two millimeters.

14. A substrate cleaning apparatus, comprising:
a brush member having an axis of rotation, the brush member including a scrubbing material; and
a support member for supporting a substrate in contact with the brush, the support member including a shaft defined through apertures on a plurality of shaft supports, the shaft extending through an aperture defined in each of the plurality of shaft supports, the shaft having a plurality of rollers defined between the plurality of shaft supports, the plurality of rollers further defined to rotate about the shaft, the shaft having an rotational axis that is parallel to the axis of rotation of the brush.

15. A substrate cleaning apparatus as defined in claim 14, wherein the support member further comprises:
a first carrier and an opposing second carrier, each carrier having a plurality of matching support slots formed on an interior face of the first carrier and the opposing second carrier.

16. A substrate cleaning apparatus as defined in claim 15, wherein the shaft supports are positioned within the support slots defined on the interior face of the first carrier and the opposing second carriers.

17. A substrate cleaning apparatus as defined in claim 16, wherein the support slots include a keying feature to align the aperture of the shaft support.

18. A substrate cleaning apparatus as defined in claim 14, wherein the shaft has a diameter of about two millimeters.

19. A substrate cleaning apparatus as defined in claim 14, wherein the support member further comprises:
a plurality of compliant members being disposed along the shaft, the plurality of compliant members being positioned between the plurality of shaft supports and the plurality of rollers.

20. A substrate cleaning apparatus as defined in claim 14, wherein the brush member includes a plurality of slits that enables the brush member to scrub opposing surfaces of the substrate.
